(19) United States
(12) Patent Application Publication
(10) Pub. No.: US 2010/0299338 A1
(43) Pub. Date: Nov. 25, 2010

(54) METHOD AND APPARATUS FOR PROVIDING DEVICE COMPATIBILITY SERVICE

(75) Inventors: Ville Aarni, Veikkola (FI); Miikka Sainio, Kerava (FI); Dmitry Kolesnikov, Vantaa (FI); Niklas Von Knorring, Helsinki (FI); Atte Lahtiranta, Bedford, MA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/468,792

(22) Filed: May 19, 2009

(51) Int. Cl. G06F 17/30

(52) U.S. Cl. 707/759; 707/769

(57) ABSTRACT

Techniques for a device compatibility service include receiving a first query from a service indicating first device identification data related to a mobile communication device. A second query is initiated into multiple sources for the mobile communication device based on the received device identification data. In response to the received first query, the method further comprises causing to be sent to the service a response that indicates different data associated with the device identification data based on a database of device characteristics, wherein the service is adapted based on the device identification data. For example, in some embodiments the device identification data indicates a specific mobile communication device and the different data indicates characteristics of the specific device. In some embodiments, the device identification data indicates a specific device characteristic and the different data indicates devices associated with the specific device characteristic in the database.

### BACKGROUND

Wireless (e.g., cellular) service providers and mobile device manufacturers are continually challenged to deliver value and convenience to consumers by, for example, providing compelling network services. With the large variety of operating systems, processor speeds, screen sizes, memory sizes, media capabilities and other characteristics of mobile devices, it is difficult for developers of mobile services and applications to know how many and which devices are able to run effectively the service client or application being developed. Similarly, it is difficult for a user of one mobile device to know what applications and services executing on mobile devices of others will also run effectively on the user's device.

### SOME EXAMPLE EMBODIMENTS

Therefore, there is a need for an approach for determining mobile device compatibility to ensure effective execution of developed services and applications.

According to one embodiment, a method comprises receiving a first query from a service indicating first device identification data related to a mobile communication device. The method further comprises initiating a second query into multiple sources for the mobile communication device based on the received device identification data. In response to the received first query, the method further comprises causing to be sent to the service a response that indicates different data associated with the device identification data based on a database of device characteristics, wherein the service is adapted based on the device identification data.

According to another embodiment, an apparatus comprising at least one processor, and at least one memory including computer program code, the at least one memory and the computer program code configured to, with the at least one processor, cause the apparatus to receive a first query from a service indicating first device identification data related to a mobile communication device. The apparatus is further caused to initiate a second query into multiple sources for the mobile communication device based on the received device identification data. In response to the received first query, the apparatus is further caused to send to the service a response that indicates different data associated with the device identification data based on a database of device characteristics, wherein the service is adapted based on the device identification data.

According to another embodiment, a computer-readable storage medium carrying one or more sequences of one or more instructions which, when executed by one or more processors, cause an apparatus to receive a first query from a service indicating first device identification data related to a mobile communication device. The apparatus is further caused to initiate a second query into multiple sources for the mobile communication device based on the received device identification data. In response to the received first query, the apparatus is further caused to send to the service a response that indicates different data associated with the device identification data based on a database of device characteristics, wherein the service is adapted based on the device identification data.

According to another embodiment, an apparatus comprises means for receiving a first query from a service indicating first device identification data related to a mobile communication device. The apparatus further comprises means for initiating a second query into multiple sources for the mobile communication device based on the received device identification data. The apparatus further comprises means for causing to be sent to the service a response that indicates different data associated with the device identification data based on a database of device characteristics, in response to the received first query, wherein the service is adapted based on the device identification data.

According to another embodiment, a method comprises granting access to receive a query indicating device identification data related to a mobile communication device. The method further comprises, in receiving the query, transmitting a response that indicates different data associated with the device identification data based on a database of device characteristics, wherein a service is adapted based on the device identification data.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of determining mobile device compatibility, according to one embodiment;

FIG. 1B is a diagram of a system to determine mobile device compatibility; according to another embodiment;

FIG. 2 is a diagram of a record in a device database, according to one embodiment;

FIG. 3A is a diagram of a message requesting compatible devices, according to one embodiment;

FIG. 3B is a diagram of a message responding with compatible devices, according to one embodiment;

FIG. 4 is a flowchart of a process for providing a device compatibility service, according to one embodiment;

FIG. 5A is a flowchart of a process for requesting device compatibility service, according to one embodiment;

FIG. 5B is a flowchart of a process for requesting device compatibility service, according to another embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF PREFERRED EMBODIMENT

A method and apparatus for providing device compatibility are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to application developers for mobile communication devices (e.g., wireless devices such as cellular telephones), it is contemplated that the approach described herein may be used in other contexts, such as by network applications, or modules executing as part of a social service, or by individual users or subscribers to a network service.

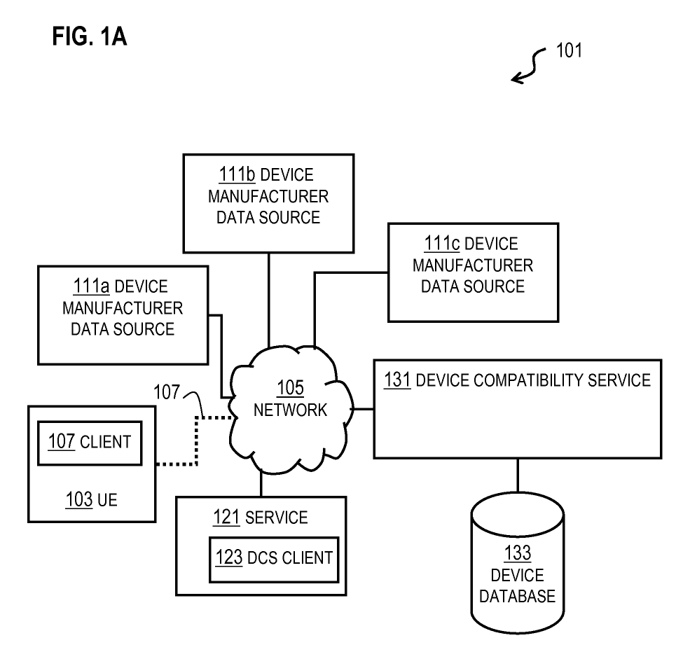

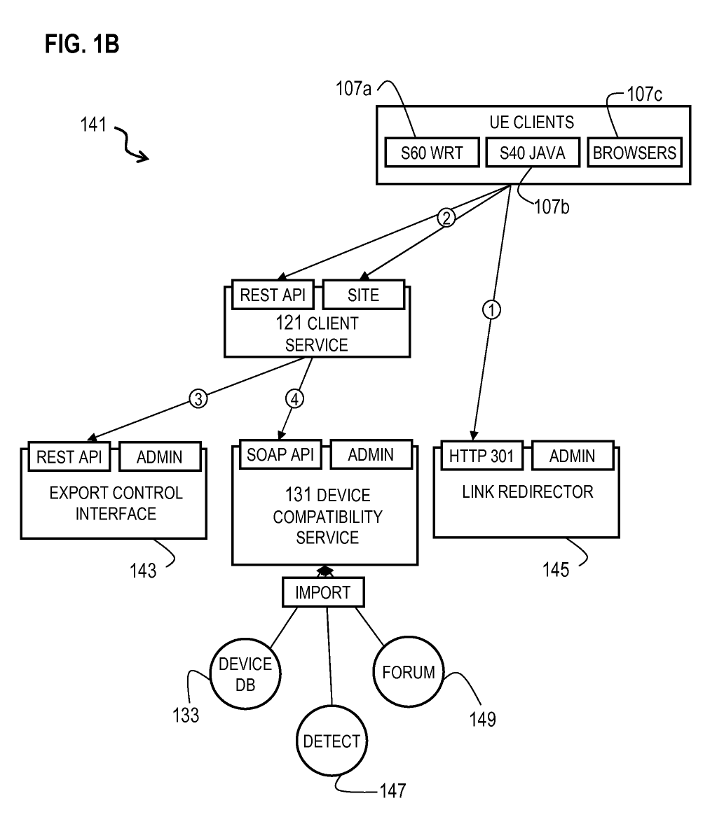

FIG. 1 is a diagram of a system 101 capable of determining mobile device compatibility, according to one embodiment. A developer of an application or service for use on a mobile communication device must rely on the hardware and software available on the mobile communication device to implement some or all of the functionality to support the service or application. Some services are stand alone applications and, once installed, operate entirely on the mobile communication device. Some services rely on a standard or special purpose client process on the mobile device interacting across a network with a server process executing on another node of the network, typically a node with more computing power.

Because of the wide variety of mobile communication device characteristics, it is unlikely that any but the most simple service or application is able to execute effectively on all such devices. There are many characteristics of importance to the developer, such as the screen size of the mobile communication device, the operating system of the device, the processing power of the device, the type of media the device can render, and the type of input a user of the device can enter, among many others, described in more detail below.

For example, the client-server model of computer process interaction is widely used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the server process can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages. Some services or applications rely on a web browser on the client. To support small screens available on many mobile communication devices, Web pages are converted to reduced representations and transmitted to mobile communication devices using the Wireless Application Protocol (WAP).

Typically, the developer has a particular device, or family of devices, in mind when the service or application is being developed; and, the developer knows the characteristics of that device or family. However, in trying to promote the service or application, it would be useful to know what other extant or emerging devices can effectively execute the functionality of the service or application. The developer would be interested in a technique to specify the characteristics of the mobile device invoked by the service or application, and determine all other mobile communication devices that possess the invoked characteristics or more.

Furthermore, a user of a particular device may want to know what other services and applications can run effectively on that particular device. For example, the user has a friend who is employing an interesting service or application, and the user is interested in knowing whether the application or service will run on the user's device. In some cases, a user of a particular device is thinking of changing an older device and wants to know what currently available devices can effectively run all the applications and services that the user currently employs or intends to employ.

In yet other applications, a developer might want to adapt a service to perform differently for different device capabilities, running or installing a faster, lighter version of the service (using less memory and CPU) for less capable devices.

To address this problem, a system of FIG. 1 introduces the capability to determine mobile device capability. The system 101 includes a device compatibility service (DCS) process 131 executing on a node (not shown) of a network 105 that grants access to the DCS. The DCS process 131 acquires the device characteristics for multiple devices, e.g., from manuals published by the device manufacturers or websites maintained by those manufacturer or some combination, and stores data indicating those characteristics in a database maintained by the DCS provider. Then, a developer, a process or other user can send queries to the DCS 131 to obtain information about the devices that have a certain characteristic or combination of characteristics, or to obtain information about the characteristics associated with a particular device. Example queries include queries to list out all the characteristics of a specific device, list out partial characteristics of a specific device, list out all the devices with a specific set of values for one or more characteristics, and list out all the devices which are similar to a specific device (e.g., similar values for operating system or media capabilities or mobile application, alone or in some combination).

As shown in FIG. 1, the system 101 comprises user equipment (UE) 103 having connectivity to a service 121, and a DCS client process 123 having connectivity to the DCS process 131, via a communication network 105. The DCS process 131 is in communication with a device database 133 on a data storage device connected, directly (as illustrated) or indirectly through network 105, to a host (not shown) of the DCS process 131.

By way of example, the communication network 105 of system 101 includes one or more networks such as a data network (not shown), a wireless network (not shown), a telephony network (not shown), or any combination thereof It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 103 and the hosts (not shown) for service process 121 and DCS process 131 are any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof It is also contemplated that the UE 103 can support any type of interface to the user (such as “wearable” circuitry, etc.). In the illustrated embodiment, UE 103 is a mobile communication device connected to network 105 through wireless link 107.

In the illustrated embodiment, multiple data sources 111a, 111b, 111c (collectively referenced hereinafter as data sources 111) for device manufacturers are also connected to network 105. These data sources 111 represent any process executing on a node of network 105 that presents information about mobile communication devices and their characteristics. For example, in some embodiments, one or more of data sources 111 is a web page provided by a web server process on a node of network 105.

The DCS client process 123 communicates with the DCS process 131 to obtain responses to queries about device characteristics or one or more mobile communication devices, such as UE 103. In the illustrated embodiment, DCS client process 123 is included in a service process 121 that communicates with client process 107 on UE 103. In this arrangement, a user of UE 103 can request information about device compatibility from service 121, which uses the DCS client 123 to obtain that information from DCS process 131 and device database 133. Also in this arrangement, a user of UE 103 can request service 121, which uses the DCS client 123 to obtain information about the capabilities of UE 103 from DCS process 131 and device database 133, and adapts its response to client 107 based on the capabilities of UE 103 obtained from the DCS process 131.

By way of example, the hosts of service 121 and DCS process 131 and data sources 111 and UE 103, and the processes themselves, including client 107 and DCS client 123, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Although a particular set of nodes, processes, and data structures, such as databases, are shown in FIG. 1 for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion. For example, in some embodiments, the DCS client 123 is outside of service 121, or service 121 and client 107 are omitted. As a further example, in some embodiments, the functions of DCS client 123 are provided by a Web browser interacting with a web page server included in DCS process 131.

FIG. 1B is a diagram of a system 141 to determine mobile device compatibility; according to another embodiment. In this embodiment, one or more clients 107, such as Wireless Receiver/Transmitter (WRT) client 107a, S40 JAVA client 107b and web browsers 107c on UE (not shown) send a request via a network (not shown) either directly to a client service 121 or indirectly to a link redirector process 145. In some embodiments the request includes a universal resource locator (URL) name for the service 121 or the redirector 145. A request to the link redirector process 145 is analyzed based on the Internet Protocol (IP) address and other data in the request and directed to an appropriate service, such as client service 121. A link redirector process 145 is used for any number of reasons, including providing user specific services, load balancing or geographic distribution, among other reasons. In some embodiments, the request includes device identification data that indicates a specific UE device hosting the client 107 or one or more characteristics of that device that are relevant for the service being requested. In some embodiments, the request includes user profile information that identifies the user as a member of a subscription service, such as a social network service.

The client service 121 then accesses an export control interface 143, if applicable, to determine whether the service being requested, e.g. content download, is permitted from the service 121 to the client 107, given the client's user or geographic location. If cleared to provide service, or tailored to the services allowed to the user by the export control interface 143, the client service 121 determines how to provide service tailored to the UE by contacting the device compatibility service (DCS) 131.

The DCS 131 uses information in a device database 133, or detected by a detect 147, or provided by a forum process 149 of the subscription service, if any, to provide a response to the client service 121. The client service then provides a response tot eh UE client 107 based on the capabilities of the UE device hosting client 107.

Thus, as depicted in FIG. 1B, in network communications indicated by numerals 1 through 4, the following actions take place. (1) Client 107 connects to the Link Redirector 145, identifies itself and is redirected to the correct service 121; (2) Client connects to the client service 121 front-end; (3) Client service 121 sends the clients' IP address to an export control interface 143, which responds with a country code based on which client service will make an export control decision; (4) Client service 121 connects to the device compatibility service (DCS) 131, sends the user-agent of the connecting client 107, and receives back the device database ID and queried device attributes, including specific device ID or device properties, or device applications, alone or in some combination. In certain embodiments, the interface 143, in addition to performing the IP address check that may fetch the country code, the interface 143 can (alternatively in additionally) fetch an export classification. For example, the export classification can be “A” when the service is available, “B” when the service is available with some restrictions, and “C” when the service restricted. This export classification may relate to geographical areas, but other conditions may exist. Further, such classification can be temporal or fixed by working hours, daily hours etc. and may or may not relate the geographical area (such as country).

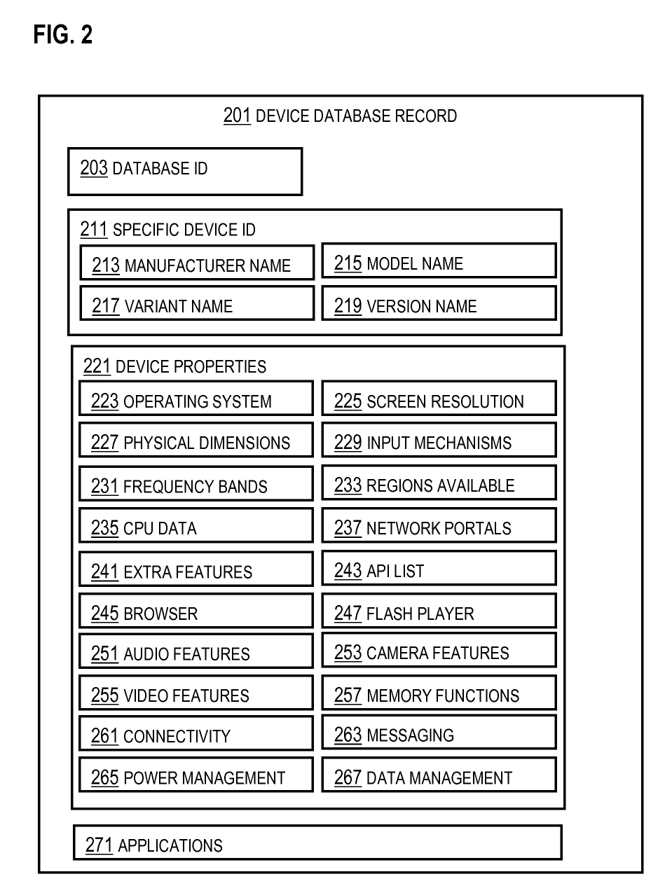

FIG. 2 is a diagram of a record 201 in a device database 133, according to one embodiment. The record 201 describes one device, and additional records describe other devices. In the illustrated embodiment, device database record 201 includes a database identifier (ID) field 203, a specific device identifier field (ID) field 211, a device properties field 221, and applications field 271. The data to fill the data fields of record 201 come from any data source, including manual input, and automated input derived from one or more of data sources 111. As used herein device characteristics (or features) includes the device properties indicated in field 221 and applications indicated in field 271, among others not listed in FIG. 2.

The database ID field 203 holds data that indicates a key into the device database, such as an index key or record sequence number. The value in the database ID field 203 is an efficient reference to all the data in a particular record 201.

The specific device ID field 211 holds data that indicates a particular version of a device. In the illustrated embodiment, the device ID field 211 includes a manufacturer name field 213, a model name field 215, a variant name field 217 and a version name field 219. The manufacturer name field 213 holds data that indicates a manufacturer of a mobile communication device. Any data may be used to indicate the manufacturer name including data that directly or indirectly identifies the manufacturer, such as text giving the name explicitly or a number code or pointer to an entry in a list of manufacturers. The model name field 215 holds data that indicates a model name or number of a mobile communication device, used by the manufacturer indicated in field 213 to distinguish different products. The variant name field 217 holds data that indicates a variant of a model used by the manufacturer to distinguish different options of the same model, e.g., a base model or a sport variant or light (“lite”) variant or enhanced variant of the base model indicated in field 215. The version name field 219 holds data that indicates a version of a variant used by the manufacturer to distinguish different temporal releases of a variant, e.g., with fixes or upgrades determined after initial release of the model and variant indicated in fields 215 and 217, respectively.

The device properties field 221 includes data that defines the capabilities of the device indicated in field 211, and thus the compatibility of that device with software or firmware developed for other devices. In the illustrated embodiment, the device properties field 221 includes fields 223 through 267, described in more detail below. Each of these fields holds data that indicates some device characteristic. It is understood herein that a device characteristic is indicated when the data explicitly (directly) states a value for the characteristic or indicates the characteristic value indirectly through a pointer or reference to another data structure or code.

The applications field 271 holds data that indicates a list of stand alone applications or service clients that are known to execute effectively on the device, e.g., based on user surveys or published data, including any pre-installed applications or clients. For purposes of illustration it is assumed that the applications field 271 holds data that indicates a list of software and data structures that includes, for example, “X social service client,” “Y navigation application,” “Z image editor,” and “software updates,” among others.

Although the depicted fields in FIG. 2 are shown as integral blocks of data in a particular order in a single data structure for purposes of illustration, in other embodiments one or more fields, or portions thereof, are arranged in a different order in one or more data structures in one or more databases residing on one or more nodes connected directly or indirectly to network 105. In some embodiments, one or more depicted fields or portions thereof are omitted, or additional fields are included.

The values of properties described in the device properties field 221 are expressed using zero or more of acronyms as listed in the following table.

Table of well known acronyms used as values in the device properties field.

| Acronym | Full Name |
|---|---|
| 3GPP | 3^{rd} Generation Partnership Project telecommunications |
| | standards body |
| A2DP | Advanced Audio Distribution Profile |
| AAC | Advanced Audio Coding |
| AAC+ | Advanced Audio Coding Plus |
| AES | Advanced Encryption Standard |
| AMR-NB | Adaptive Multi-Rate Narrow Band |
| AMR-WB | Adaptive Multi-Rate Wide Band |
| API | Application Programming Interface |
| AU | Audio format from SUN MICROSYSTEMS ™ |
| | Mountain View CA |
| AVC | Advanced Video Coding, |
| | MPEG-AVC is equivalent to MPEG-4 Part 10, or H.264 |
| AVDTP | Audio/Video Distribution Transport Protocol |
| AWB | AMR Wide Band, equivalent to AMR-WB |
| BIP | Bearer Independent Protocol |
| BMP | Bit-mapped picture |
| byte | eight binary digits (bits) |
| C, C++ | Programming languages |
| centi | 10⁻² |
| CMOS | Complementary Metal-Oxide Semiconductor |
| CPU | Central processing unit |
| CSD | Circuit switched data |
| DRM | Digital rights management |
| DUN | Dial-up Networking |
| eAAC+ | Trade name for High-Efficiency Advanced Audio |
| | Coding (HE-AAC) |
| EDR | Enhanced Data Rate |
| EGPRS | Enhanced General Packet Radio Service |
| EXIF | Exchangeable Image File Format |
| FM | Frequency modulated |
| FOTA | Firmware Over-The-Air |
| fps | frames per second |
| FTP | File Transfer Protocol |
| GAP | GMS access protocol |
| GB | Gigabytes = 10⁹ bytes, |
| GIF## | Graphics Interchange Format version year ## |
| Giga | 10⁹ |
| GOEP | Generic Object Exchange Profile |
| GPRS | General Packet Radio Service |
| GPS | Global Positioning System |
| GSM ### | Global System for Mobile communications |
| | at MegaHertz frequency indicated by ### |
| H263 | video codec standard |
| H264 | standard for video compression |
| HFP | Hands Free Protocol |
| HID | Human interface device |
| HSCSD | High-speed Circuit-Switched Data |
| HSDPA | High-Speed Downlink Packet Access |
| HSP | Bluetooth enabled headset |
| HTML | Hypertext Markup Language |
| HTTP | Hypertext Transfer Protocol |
| IEEE | Institute of Electrical and Electronics Engineers |
| IM | Instant Messaging |
| IMAP# | Internet Message Access Protocol version # |
| IP | Internet Protocol |
| JAR | JAVA Archive |
| JAVA | The JAVA programming language from |
| | SUN MICROSYSTEMS ™ |
| JPEG#### | Joint Photographic Experts Group image format |
| | version year #### |
| M4A | audio layer of MPEG 4 |
| MB | Megbyte = 10⁶ bytes |
| MBM | MyBitmap image format |
| Mega | 10⁶ |
| MIDI | Musical Instrument Digital Interface |
| milli | 10⁻³ |
| MMS | Multimedia Message Service |
| Mobile XMF | a mobile member of a family of music-related file |
| | formats created and administered by the MIDI |
| MP3 | MPEG-1 Audio Layer 3 |
| MP4 | MPEG-4 Part 14 |
| MPEG-# | Moving Picture Experts Group video format version # |
| MTP | Multimedia Transfer Protocol |
| NAND | Not AND Flash Memory |
| OMA | Open Mobile Alliance |
| OPP | Bluetooth Object Push Profile |
| OS | Operating system |
| OTA | Over The Air Bitmap image format |
| PBAP | Bluetooth Phone Book Access Profile |
| PDF | Portable Document Format |
| pixels | Picture elements |
| PNG | Portable Network Graphic |
| POP# | Post Office Protocol version # |
| QWERTY | Keyboard arranged starting with the letters QWERTY |
| RMF | proprietary format of BEATNIK ™ of |
| | San Mateo, California |
| SAP | Session Announcement Protocol |
| SDP | Session Description Protocol |
| SDRAM | Synchronous dynamic random access memory |
| SMIL | Synchronized Multimedia Integration Language |
| SMS | Short Message Service |
| SMTP | Simple Mail Transfer Protocol |
| SND | Sound format |
| SP-MIDI | Scalable Polyphony MIDI |
| TCP | Transmission Control Protocol |
| TIFF | Tagged Image File Format |
| TKIP | Temporal Key Integrity Protocol |
| TV | Television |
| USB | Universal Serial Bus |
| VLAN | virtual local area network |
| WAP | Wireless Application Protocol |
| WAV | Waveform Audio Format |
| WBMP | Wireless Application Protocol Bitmap Format |
| WCDMA ### | wideband code division multiple access at |
| | MegaHertz frequency indicated by ### |
| WEP | Wired Equivalent Privacy |
| WMA | Windows Media Audio |
| WMF | Windows Metafile |
| WMV | Windows Media Video |
| WPA# | Wi-Fi Protected Access version # |
| WVE | Psion Series 3a/3c/3mx Waveform Sound File |
| XHTML | Extended Hypertext Markup Language |

In the illustrated embodiment, the device properties field 221 includes the operating system field 223 that holds data that indicates one or more operating systems on the device indicated in field 211. Most software processes, such as clients and stand alone applications, interact with a device through operating system commands. An example operating system indicated in field 223 is the Symbian operating system (OS) version 8.4.

The screen resolution field 225 holds data that indicates the number of rows and columns of picture elements (pixels) in the display screen on the device. This characteristic is often a limiting factor in designing an application to perform suitably on a device. In some embodiments, the screen resolution field includes data that indicates the color depth, e.g. the number of bits allowed to specify the color at any one pixel.

The physical dimensions field 227 holds data that indicates the length, width, thickness, weight or physical appearance of a device, such as body shape or color, alone or in some combination. Any or all of these characteristics may affect the style of interface presented to a user by a service or application.

The input mechanisms field 229 holds data that indicates how a user of the device can input data to the device, which impacts how the service or application presents options to the user. For purposes of illustration, it is assumed that the input mechanisms field 229 holds data that indicates a list that includes, for example, “Applications key,” “Call Creation key,” “Call Termination key,” “Dedicated Camera key,” “Dedicated Volume keys,” “Slide Out QWERTY keyboard,” and “Touch Screen.”

The frequency bands field 231 holds data that indicates one or more radio frequency bands used by the device to form wireless links, e.g., link 107. For purposes of illustration, it is assumed that the frequency bands field 229 holds data that indicates a list that includes, for example, “GSM 850,” “GSM 900,” “GSM 1800,” “GSM 1900,” “WCDMA 850,” “WCDMA 900,” “WCDMA 1800,” and “WCDMA 1900,”

The regions available field 233 holds data that indicates one or more regions where the device is available. This may impact the language and character set presented to a user. For purposes of illustration, it is assumed that the regions available field 233 holds data that indicates a list that includes, for example, “Africa,” “Asia-pacific,” “China,” “Europe,” “Latin America,” “Middle East,” and “North America” for worldwide availability.

The central processing unit (CPU) data field 235 holds data that indicates one or more CPUs on the device. This may impact the speed with which a particular client process or application can perform, especially when the device is not in communication with the network. For purposes of illustration, it is assumed that the CPU data field 235 holds data that indicates, for example, a number of CPU, a CPU manufacturer/model, and a CPU clock rate.

The network portals field 237 holds data that indicates network protocols and links used by the device. This may impact the way that data and instructions are delivered to the device. For purposes of illustration, it is assumed that the network portals field 237 holds data that indicates a data bearer's list that includes, for example, “CSD,” “Dual Transfer Mode,” “EGPRS,” “GPRS,” “H SCSD,” “HSDPA,” “WCDMA,” and data indicating profile links, a consumer link (e.g., Products Home Page), a developer link (e.g., Developer Home Page), and a remote device access services link.

The extra features field 241 holds data that indicates additional firmware/hardware modules available on the device. This significantly impacts the way functionality is implemented for the device. For purposes of illustration, it is assumed that the extra features field 241 holds data that indicates a list that includes, for example, “Accelerometer,” “Ambient Light Sensor,” “Compass,” “Flight Mode,” “FOTA Firmware over the Air,” “Magnetometer,” “Proximity Sensor,” “Stereo FM radio,” “Stereo hands free speakers” “television (TV) output,” and “A-global positioning system (GPS).”

The application program interface (API) field 243 holds data that indicates interfaces to software modules available on the device. This also impacts the way functionality is implemented for the device. For purposes of illustration, it is assumed that the API field 243 holds data that indicates a list of APIs that includes, for example, JAVA technologies, JAVA Access Permissions, Home Screen Publishing, Open C, Open C++, Out of Memory Monitor client, Sensor Data Compensator, Sensor Channels, and Authentication Certificates.

The browser field 245 holds data that indicates the installed browsers to operate on HTTP messages. For purposes of illustration, it is assumed that the browser field 245 holds data that indicates a list that includes, for example, Hypertext Markup Language over Transmission control Protocol embedded in the Internet Protocol (“HTML over TCP/IP”), “OSS browser,” “WAP 2.0,” “Web Runtime 1.1.,” and extended HTML “(XHTML) over TCP/IP.”

The flash player field 247 holds data that indicates the installed flash player on the device for rendering various media. For purposes of illustration, it is assumed that the flash player field 247 holds data that indicates, for example, a Flash player model and version.

The audio features field 251 holds data that indicates audio formats that can be rendered on the device and audio input and output components. For purposes of illustration, it is assumed that the audio features field 251 holds data that indicates a list of well known audio formats that includes, for example, “AAC,” “AAC+,” “AMR-NB,” “AMR-WB,” “AU,” “AWB,” “eAAC+,” “M4A,” “MIDI,” “Tones(poly 64),” “Mobile XMF,” “MP3,” “MP4,” “RealAudio 7, 8, 10,” “RMF,” “SND,” “SP-MIDI,” “True tones,” “WAV,” “WMA,” and “WVE;” and a list of well known audio modules that includes, for example, “Audio Equalizer,” “Audio Recording AAC,” “Audio Streaming,” “Bluetooth Stereo,” “FM transmitter (88.1-107.9 MegaHz),” “Loudness,” “Music Player,” and “Stereo Widening.”

The camera features field 253 holds data that describes a digital camera in the mobile communications device. For purposes of illustration, it is assumed that the camera features field 253 holds data that indicates camera resolution in rows and columns of pixels (e.g., 2592×1944), CMOS sensor (e.g., 5 Megapixels), digital zoom (e.g., 4 times), focal length (e.g., 5.4 millimeters), F-stop/Aperture (e.g., f/2.8), focus range (e.g., 10 centimeters to infinity), image format (e.g., JPEG/Exif), camera features (e.g., a list that includes “Auto Exposure,” “Auto Focus,” “Carl Zeiss Optics,” “Exposure Compensation,” “Flash,” “Full Screen Viewfinder,” “Self Timer,” “Sequence Mode”), secondary resolution (e.g., 640×480), secondary digital zoom (e.g., 2 times), and secondary image format (e.g., JPEG).

The video features field 255 holds data that describes video clips compiled by the camera. For purposes of illustration, it is assumed that the video features field 255 holds data that indicates recording resolution (e.g., 640×480 pixels), recording frame rate (e.g., 30 frames per second, fps), recording zoom (e.g., 4 times), a list of recording formats (e.g., “H263” and “MPEG-4”), a list of video features (e.g., “Video Call,” “Video Editor,” “Video Player,” “Video Recorder,” “Video Ringtones,” “Video Sharing,” and “Video Streaming”), a list of video playback formats (e.g., “3GPPformats-H263,” “Flash Video,” “H264/AVC,” “MPEG-4,” “RealVideo 7, 8, 9/10,” and “WMV 9”), playback frame rate (e.g., 30 fps), and a list of graphic formats (e.g., “BMP,” “EXIF,” “GIF87a,” “GIF89a,” “JPEG,” “JPEG2000,” “MBM,” “OTA,” “PNG,” “TIFF,” “WBMP,” and “WMF”).

The memory functions field 257 holds data that indicates the properties of the device memory. For purposes of illustration, it is assumed that the memory functions field 257 holds data that indicates mass storage memory (e.g., 32 Gigabytes, GB), NAND memory (e.g., 256 Megabytes, MB), SDRAM memory (e.g., 128 MB), memory card type, a list of memory card features (e.g., “Hot Swap”), maximum memory card size (e.g., 16 GB), maximum heap size and maximum JAR size.

The connectivity field 261 holds data that indicates the types of links supported by the device. For purposes of illustration, it is assumed that the connectivity field 261 holds data that indicates a list of local connection channels (e.g., “Bluetooth 2.0 +EDR,” “Bluetooth Stereo Audio,” “X Manufacturer USB,” “Multimedia Transfer Protocol (MTP)”), a list of Bluetooth profiles (e.g., “A2DP,” “AVDTP,” “BIP,” “DUN,” “FTP,” “GAP,” “GOEP,” “HFP,” “HID,” “HSP,” “OPP,” “PBAP,” “SAP,” and “SDP”), and a list of virtual local area network (VLAN) support protocols (e.g., “IEEE 802.11b/g,” “WEP,” “WPA,” and “WPA2 (AES/TKIP)”).

The messaging field 263 holds data that indicates the types of messaging protocols supported by the device. For purposes of illustration, it is assumed that the messaging field 263 holds data that indicates a list of protocols (e.g., “IM” “MMS+SMIL,” and “SMS,”), a list of messaging features (e.g., “OMA Multimedia Messaging Service v1.3”), a list of email solutions (e.g., “Mail for Exchange,” “OMA Email Notification v1.0”), a list of email protocols (e.g., “IMAP4,” “POP3,” “SMTP”), and a list of document formats (e.g., “Excel,” “PDF,” “Powerpoint,” “Word,” and “Zip”).

The power management field 265 holds data that indicates the power features of the device. For purposes of illustration, it is assumed that the power management field 265 holds data that indicates power management technique (e.g., USB charging), battery type, GSM talk time (e.g., 9.5 hours), WCDMA Talk Time (e.g., 6.0 hours), GSM standby time (e.g., 18 days), WCDMA standby time (e.g., 17 days), video playback time (e.g., 4.5 hours), video recording time (e.g., 3.6 hours), and music playback time (e.g., 40 hours).

The data management field 267 holds data that indicates the data management features of the device. For purposes of illustration, it is assumed that the data management field 267 holds data that indicates client provisioning, device management, data synchronization, a list of digital rights management (DRM) applications, and a DRM delivery method.

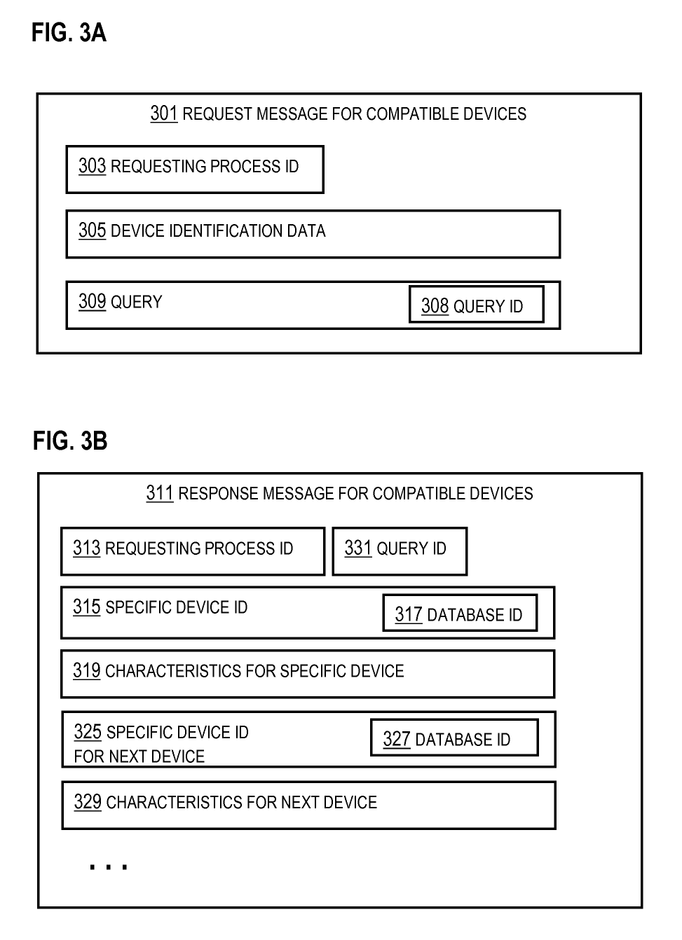

FIG. 3A is a diagram of a message 301 requesting compatible devices, according to one embodiment. The message 301 includes a requesting process identifier (ID) field 303, a device identification data field 305 and a query field 309.

The requesting process ID field 303 holds data that indicates the process on a network that originated the request for device compatibility information, such as an Internet Protocol (IP) address and Transmission Control Protocol (TCP) port number or an SMS telephone number. This identifies the process, called a user agent, which is to receive the results of the request in embodiments in which the request is relayed by another process. For example, in embodiments in which the client 103 indicates a selection to service 121 that involves a response from the DCS 131, the service invokes the DCS client 123 and passes the IP address and TCP port (or SMS phone number) of the client 103 to the DCS client, which includes that requesting process ID in the request sent to the DCS service 131.

The device identification data field 305 holds data that indicates a specific device that is used to specify a condition of a query, such as a manufacturer name, model name, variant name and version name of the specific device. In some embodiments, a family of devices is the condition of the query; and the version or variant or model name is omitted from the device ID field 305. In some embodiments, a characteristic rather than a device is a condition of the query; and the device identification data field 305 indicates the one or more characteristics. In some embodiments the requesting process ID field includes data that identifies a particular user of the process, such as all or part of a user profile on a social network service. In some embodiments, the requesting process ID field 303 includes a time stamp that indicates when the message 301 was initiated

The query field 309 holds data that indicates a query of the database. For example, the query field 309 holds data that indicates a request for all characteristics of a device indicated in field 305. As another example, the query field 309 holds data that indicates a request for certain enumerated characteristics of a device indicated in field 305. As another example, the query field 309 holds data that indicates a request for all devices with certain characteristics or applications. In yet another example, the query field 309 holds data that indicates a request for all devices with characteristics or applications similar to those of a device indicated in the field 305. In some of these embodiments, the query also indicates particular characteristics to include or exclude in the determination of similarity. Any method may be used to indicate the conditions of the query based on the characteristics or devices and values ranges indicated in field 305. For example, in some embodiments the Structured Query Language (SQL) is used to express the query included in query field 309.

In the illustrated embodiment, the query field 309 include a query identifier (ID) field 308 that holds data that uniquely identifies the query at the requesting process indicated in field 303, so that response message can indicate the query that produced the result in the response message. In various embodiments, the Query ID field 308 is a time stamp of the time when the query was formed or the message 301 is formed.

FIG. 3B is a diagram of a message 311 responding with compatible devices, according to one embodiment. The message 311 includes field 313, field 315, field 319, field 325, field 329 and other pairs of fields indicated by the ellipsis.

Field 313 holds data that indicates the requesting process ID, e.g., a user agent, for which message 311 is a response. In some embodiments, message 311 is returned directly to the requesting process and field 313 forms part of the network protocol headers, such as TCP/IP headers, or SMS destination phone number. In some embodiments, message 311 is returned to another process, such as service 121, and service 121 uses the data in field 313 to identify the client 107 to which the service 121 sends a response based, at least in part, on data in the message 311.

The Query ID field 331 holds data that uniquely identifies the query sent by the process indicated in field 313.

The field 315 holds data that indicates a specific device identifier (ID), e.g., values for all fields 213, 215, 217 and 219, for the same device, if any, specified in the request message, e.g., in field 305 described above. Field 315 includes Database identifier field 317 that holds data that indicates the reference (e.g., database ID in field 203) to the device database record (e.g., record 201) associated with the device specified in the request message. In some embodiments, field 317 is omitted.

The field 319 holds data that indicates one or more characteristics for the same device, if any, specified in the request message, e.g., in field 305 described above. If no device is specified in request message 301, e.g., if field 305 is omitted, then, in some embodiments, field 319 holds data that indicates the characteristics specified in the request message, e.g., in field 307 described above.

The field 325 holds data that indicates a specific device ID for the next device, if any, that satisfies the query indicated in field 309 of the request message 301. In the illustrated embodiment, the field 325 includes database ID field 327 that holds the reference to the device database record associated with the next device, if any. If no device satisfies the query, then, in some embodiments, field 325 is omitted.

The field 329 holds data that indicates one or more characteristics for the next device, if any, that satisfies the query indicated in field 309 of the request message 301. If no device satisfies the request, e.g., if field 325 is omitted, then, in some embodiments, field 329 holds data that indicates the next characteristics, if any, that satisfy the query.

Other pairs of fields, if any, for the next device or characteristics or both that satisfy the query, analogous to fields 325 and field 329, are indicated by the ellipsis.

Although the depicted fields in FIG. 3A and FIG. 3B are shown as integral blocks of data in a particular order in a single message for purposes of illustration, in other embodiments one or more fields, or portions thereof, are arranged in a different order in one or more messages or data packets. In some other embodiments, one or more depicted fields or portions thereof are omitted, or additional fields are included.

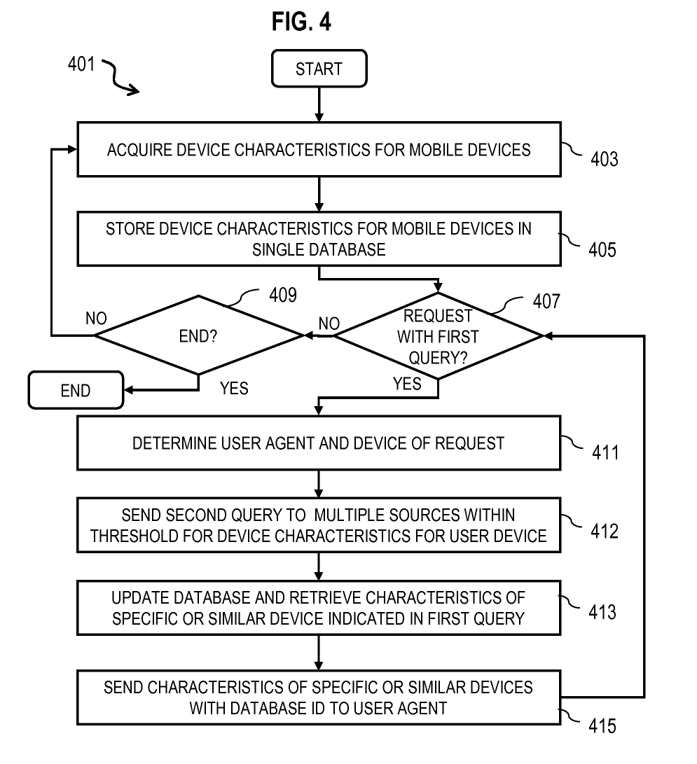

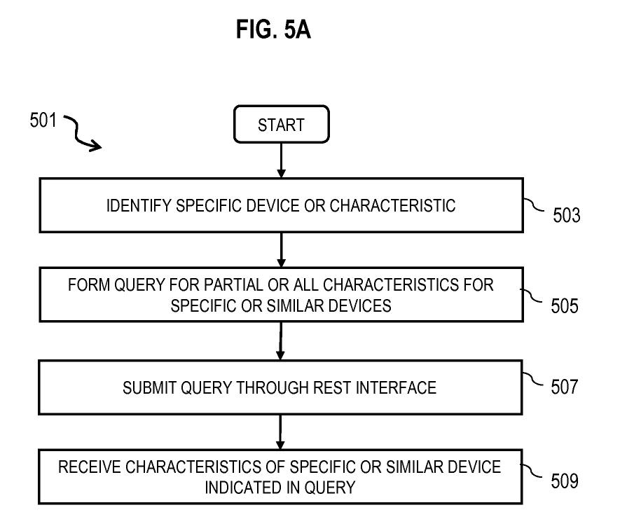

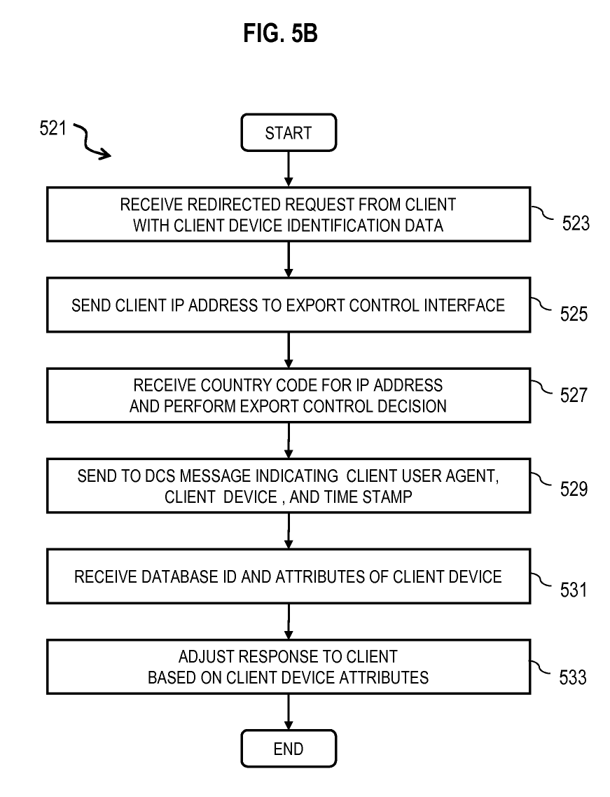

FIG. 4 is a flowchart of a process 401 for providing a device compatibility service, according to one embodiment. Although steps in FIG. 4 and subsequent flow chart FIG. 5A and FIG. 5B are shown in a particular order for purposes of illustration, in other embodiments, one or more steps may be performed in a different order or overlapping in time, in series or in parallel, or one or more steps may be omitted or added, or changed in some combination of ways.

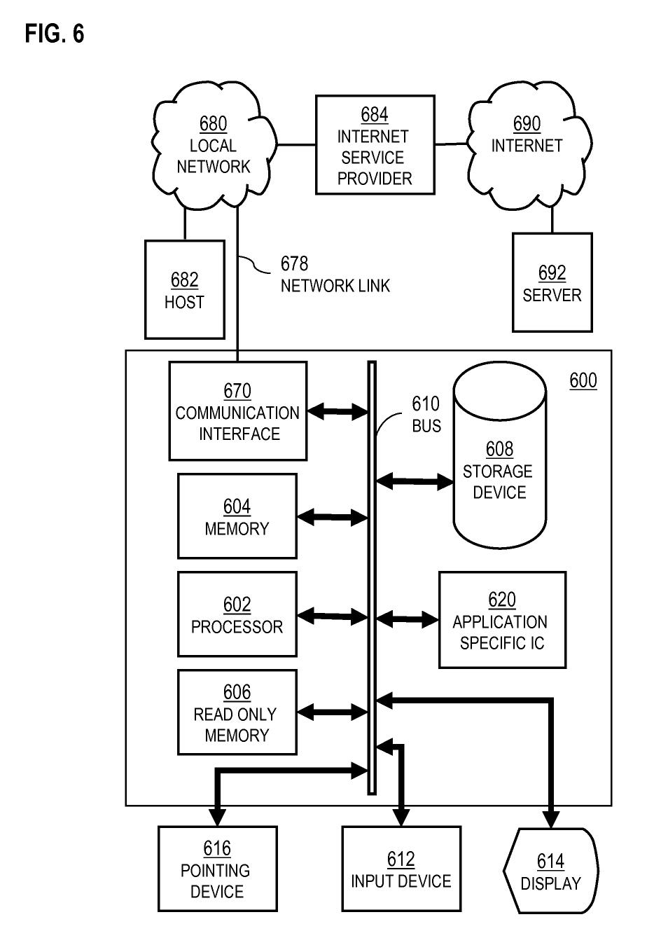

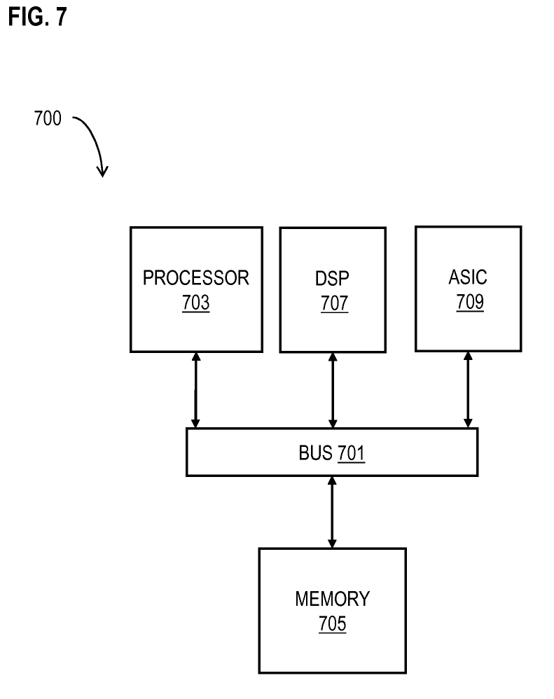

In one embodiment, the DCS 131 performs the process 401 and is implemented in, for instance, a chip set including a processor and a memory as shown FIG. 7 or a computer 600 as depicted in FIG. 6, both described in more detail below.

In step 403, device characteristics are acquired for multiple mobile communications devices, such as cellular telephones. Any method may be used to acquire this information. In various embodiments, the characteristics acquired are any or all of the characteristics described above for the device database record 201. In some embodiments, additional characteristics are acquired. In some embodiments, a human manually inputs some or all of the information from specification documents available from one or more manufacturers of mobile communications devices. In some embodiments, the information is obtained automatically, e.g., from news services, email notifications, or spider processes that invoke and scan the websites of various equipment manufacturers and cull values for the characteristics of interest. In some embodiments, the device characteristics are acquired on demand, e.g., when a request is received (such as in step 407, described below) indicating the device.

In step 405, the acquired characteristics are analyzed, organized and stored in a database, e.g., a database for device database records like the record 201 depicted in FIG. 2. For example, in a relational database one or more characteristic names represented by fields in FIG. 2 are columns in one or more tables, and data in those columns represent values for the corresponding characteristic, e.g., values in the corresponding fields. Different devices are represented by different rows in the one or more tables.

In step 407, it is determined whether a request message is received. If not, then in step 409 it is determined whether the process is to end for any reason. If so, the process ends. Otherwise, acquiring device characteristics continues in step 403, described above.

If it is determined in step 407 that a request is received, e.g., request message 301 is received, then in step 411 the user agent for the request is determined. The user agent identifies the process that initiated the request or sent the request message. In some embodiments, the SMS telephone number for UE 103 is the user agent for the process 107 that initiated the request. It is assumed for purposes of illustration that the TCP port/IP address of DCS client 123 is the user agent that initiated the request. In some embodiments, the user agent also indicates the user, e.g., from a user profile, and one or more characteristics for the device, such as the one or more fields of the specific device ID or corresponding database ID.

In step 412 a second query is sent to multiple sources of device information for the latest information about the device indicated. Thus, step 412 involves initiating a second query into multiple sources for the mobile communication device based on the received device identification data. In some embodiments, the database is first checked to convert characteristics of the device into a specific device ID that can be used to identify the manufacturer or website associated with the device, e.g., in network portals field 237.

In some embodiments, the second query is sent within a threshold time of the time stamp included in the request message 301.

In step 413, the characteristics of the device specified in the request, if any, or similar devices, or their characteristics, are retrieved from the database based on the query. For purposes of illustration it is assumed that the field 305 indicates manufacturer A, model B, variant C, version D, designated herein “device=A/B/C/D”, and that the query field 309 indicates “GET ALL CHARACTERISTICS FOR DEVICE” and Query ID field 331 indicates “12345.” Then, in step 413, all the characteristics of device=A/B/C/D are retrieved. For purposes of illustration, it is assumed that the characteristics and values indicated above for database record 201 are retrieved from the database. It is further assumed that the value of the database ID field 203 is “98765” for the record 201 that has the value A/B/C/D in device ID field 211.

In step 415, the characteristics of the specific or similar devices, if any, are returned to the user agent along with the device database IDs of any listed devices. For purposes of illustration, it is assumed that the characteristics and values indicated above for database record 201 are returned to DCS client 123 in response message 311. For example, the requesting process ID field 313 holds data indicating DCS client 123 and the query ID field 331 hold data that indicates “12345”. The field 315 includes data indicating “A/B/C/D” or the database ID field 317 holds data that indicates “98765” or both. The field 319 holds data that indicates the values indicated above for database record 201. Field 325 and field 329 and further fields indicated by ellipsis are omitted.

In response to receiving the message 311, the client service 121 adjusts its response to client 107, e.g., by sending thumbnails instead of full images. Thus the service is adapted based on the device identification data.

Control passes back to step 407 and following steps to determine whether another request is received or, if not, to either end or continue acquiring data.

For purposes of further illustration it is assumed that the field 305 indicates “device=A/B/C/D”, and a list of names of characteristics, e.g., “characteristics: operating system, applications” and that the query field 309 indicates “GET LISTED CHARACTERISTICS FOR DEVICE” and Query ID field 331 indicates “12346.” Then, in step 412 the database is updated by sending queries to other data sources, such as sources 111; and in step 413, the listed characteristics of device=A/B/C/D are retrieved. For purposes of illustration, it is assumed that the values indicated above for the listed characteristics of database record 201 are retrieved from the database, e.g., operating system=Symbian OS v8.4 and applications=X social service client, Y navigation application, Z image editor, software updates. In step 415, the response message 311 is sent, in which the requesting process ID field 313 holds data indicating DCS client 123 and the query ID field 331 holds data that indicates “12346”. The field 315 includes data indicating “A/B/C/D” or the database ID field 317 holds data that indicates “98765” or both. The field 319 holds data that indicates “operating system=Symbian OS v8.4 and applications=X social service client, Y navigation application, Z image editor, software updates”. Field 325 and field 329 and further fields indicated by ellipsis are omitted.

For purposes of further illustration it is assumed that the field indicates a list of names and values of characteristics, e.g., “operating system=Symbian, applications=Y navigation application” and that the query field 309 indicates “GET DEVICES HAVING LISTED CHARACTERISTICS” and Query ID field 331 indicates “12347.” Then, in step 413, the devices with the listed characteristics are retrieved. For purposes of illustration, it is assumed that device A/B/C/D with Database ID “98765” along with multiple other devices, including devices A/B/C/D−1; A/B/C/D−2: and A/B/C/D+1, with corresponding different Database IDs are retrieved from the database. In step 412, the database for these devices is updated by sending queries to other data sources, such as sources 111. In step 415, the response message 311 is sent, in which the requesting process ID field 313 holds data indicating DCS client 123 and the query ID field 331 holds data that indicates “12347”. The field 315 is omitted because no device was specified in the request message 301. The field 319 holds data that indicates the characteristics condition of the query, e.g., “operating system=Symbian, applications=Y navigation application.” Field 325 and 3 further fields for the next device that satisfies the query hold data that indicates the devices A/B/C/D; A/B/C/D−1; A/B/C/D−2: and A/B/C/D+1, respectively, along with their Database IDs. In some embodiments, field 329 and further fields indicated by ellipsis hold data that indicates the operating systems and applications of the corresponding devices. In some embodiments, characteristics field 329 and further fields indicated by ellipsis are omitted.

For purposes of further illustration it is assumed that the field 305 indicates “device=A/B/C/D”, and a list of names of characteristics, e.g., “operating system, applications” and that the query field 309 indicates “GET DEVICES HAVING SIMILAR CHARACTERISTICS” and Query ID field 331 indicates “12348.” In step 412, the database is updated by sending queries to other data sources, such as sources 111. Then, in step 413, the listed characteristics of device=A/B/C/D and other devices are retrieved and devices with similar values are determined. Any method for determining similarity may be used, such as percentage of characters in the same order greater than a first percentage threshold for text data and a percentage difference less than a second threshold percentage for numerical values. Only values of characteristics listed in field 307 are considered. In some embodiments, field 307 is also omitted and all characteristics are considered in determining similar devices. In some embodiments, field 307 is also omitted but only certain, default characteristics are considered in determining similar devices, such as operating system, media capabilities, and CPU clock speeds.

For purposes of illustration, it is assumed that devices A/B/C/D−1; A/B/C/D-2: A/B/C/D+1; and W/X/Y/Z satisfy the condition of similarity. In step 415, the response message 311 is sent, in which the requesting process ID field 313 holds data indicating DCS client 123 and the query ID field 331 hold data that indicates “12348”. The field 315 holds data that indicates the device A/B/C/D specified in the request message 301. The field 319 holds data that indicates the characteristics condition of the query, e.g., “operating system, applications.” Field 325 and 3 further fields for the next device that satisfies the query hold data that indicates the devices A/B/C/D−1; A/B/C/D−2: A/B/C/D+1; and W/X/Y/Z, respectively, along with their Database IDs. In some embodiments, field 329 and further fields indicated by ellipsis hold data that indicates the operating systems and applications of the corresponding devices. In some embodiments, field 329 and further fields indicated by ellipsis for characteristics of the next device are omitted.

In the above examples, it is demonstrated that the queries cause the DCS 131 to list out all the characteristics of a specific device, or partial characteristics of a specific device, or all the devices with specific characteristics, or all devices which are similar to the specified device. In other embodiments, other queries are supported by the DCS 131.

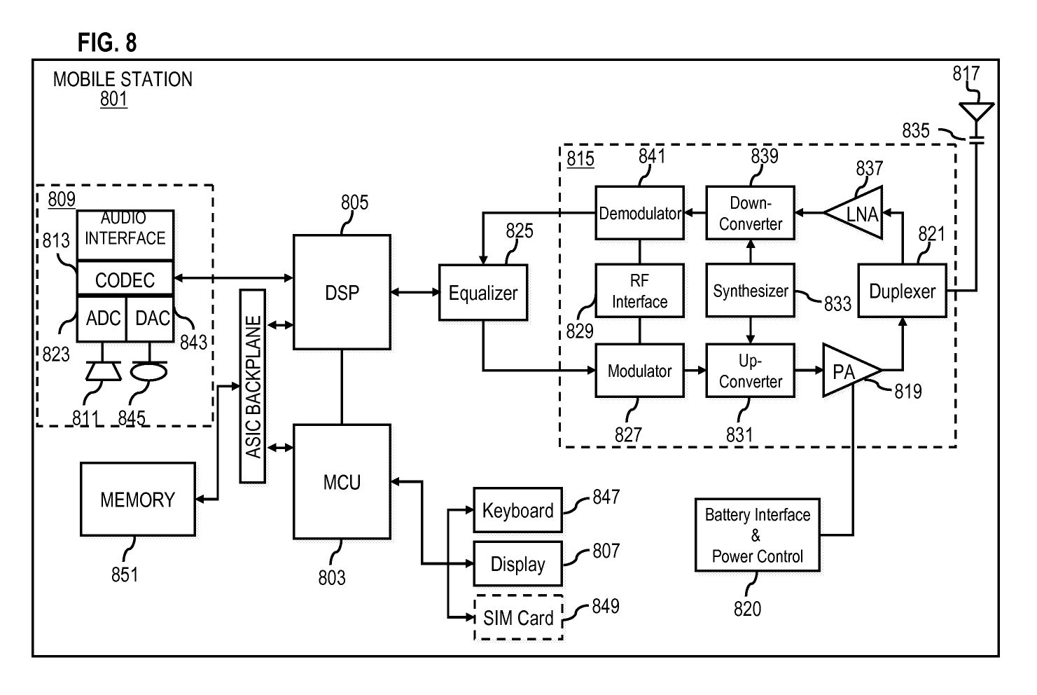

FIG. 5A is a flowchart of a process 501 for requesting device compatibility service, according to one embodiment. In one embodiment, the DCS client 123 performs the process 501 and is implemented in, for instance, a chip set including a processor and a memory as shown FIG. 7 or a computer 600 as depicted in FIG. 6. In one embodiment, the client 107 performs the process 501 and is implemented in, for instance, the chip set shown FIG. 7 or a computer 600 as depicted in FIG. 6 or mobile terminal depicted in FIG. 8.

In step 503, a specific device or set of one or more specific characteristics are identified or both. For example, a developer inputs to service 121 data indicating a device for which an application is being developed, or a user indicates a device of a friend or an application executing on a friend's device.

In step 505 a query is formed to retrieve some or all characteristics for the specific device or to retrieve one or more devices based on one or more characteristics or similarities.

In step 507, the query is submitted through a REST interface, e.g., in message 301, as described above, launched by a web browser.

In step 509, a response is received with the characteristics of the specific device or with one or more devices based on one or more characteristics or similarities, e.g., in message 311, as described above. Based on the response, the user or developer is able to ascertain whether or what mobile communication device will execute the application or client of interest, such as an application or client under development.

FIG. 5B is a flowchart of a process 521 for requesting device compatibility service, according to another embodiment. In step 523 a redirected request from client 107 and link redirector 145 is received at a service, e.g., service 121. The request includes client device identification data, such as a specific device ID of UE 103 or one or more characteristics of the device or the user profile or some combination.

In step 525, the service 121 sends the client IP address from the request to the export control interface, such as export control interface 143. In step 527, the service 121 receives the country code for the IP address and determines the export control decision, as to what content can be provided to the client 107. Before providing the content, the service 121 determines the capabilities of the UE 103 on which the client 107 is executing.

In step 529, a DCS request message 301 is formed by the DCS client 123 in service 121 and sent to the DCS 131. For example, the user agent including the TCP/IP address, is included in field 303. The device identification data, including the user profile or one or more values for the fields of the specific device ID or one or more characteristics of the device provided by the request from the client 107 or some combination, and a time stamp for the time the request is inserted in field 305. The query field includes the query from the data base of interest to the service, e.g., the screen size of the device(s) indicted in field 305. The message 301 is sent by DCS client 123 to DCS 131.

In step 531, the DCS client receives the DCS response message 311 and determines the characteristics or devices or both that satisfy the query along with the database IDs of the corresponding devices. Thus the service 121 receives the database ID and the queried device attributes.

In step 533, the service 121 sends a response to the client 107 that is adjusted based on the client device attributes, such as the screen size, received from the DCS 131.

The processes described herein for providing device compatibility may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof Such exemplary hardware for performing the described functions is detailed below.

FIG. 6 illustrates a computer system 600 upon which an embodiment of the invention may be implemented. Computer system 600 is programmed (e.g., via computer program code or instructions) to provide device compatibility are disclosed as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to provide device compatibility. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing device compatibility. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing device compatibility, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, which carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for provide device compatibility to the UE 103.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 7 illustrates a chip set 700 upon which an embodiment of the invention may be implemented. Chip set 700 is programmed to provide device compatibility as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide device compatibility. The memory 705 also stores the data associated with or generated by the execution of the inventive steps.

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to provide device compatibility. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a first query from a service indicating device identification data related to a mobile communication device;
initiating a second query into multiple sources for the mobile communication device based on the received device identification data; and
in response to the received first query, causing to be sent to the service a response that indicates different data associated with the device identification data based on a database of device characteristics, wherein the service is adapted based on the device identification data.

2. A method of claim 1, wherein the device identification data comprises a time stamp and the second query is initiated within a threshold time of the time stamp.

3. A method of claim 1, wherein the device identification data is included in a request message directed to a universal resource locator (URL) for the service or for a redirection address for the service.

4. A method of claim 1, wherein the device identification data comprises user profile data.

5. A method of claim 1, wherein the device identification data indicates a specific mobile communication device and the different data indicates a device characteristic of the specific mobile communication device.

6. A method of claim 1, wherein the device identification data indicates a specific device characteristic and the different data indicates one or more mobile communication devices associated with the specific device characteristic in the database.

7. A method of claim 1, wherein the device identification data indicates a specific mobile communication device and the different data indicates a different mobile communication device that is similar to the specific mobile communication device based on a set of one or more device characteristics associated with the specific mobile communication device and the different mobile communication device in the database.

8. A method of claim 1, wherein the database further comprises data indicating a plurality of device characteristics for a plurality of manufacturers.

9. An apparatus comprising:
at least one processor; and
at least one memory including computer program code, the memory and the computer program code configured to, with the processor, cause the apparatus to perform at least the following:
receiving a first query from a service indicating device identification data related to a mobile communication device;
initiating a second query into multiple sources for the mobile communication device based on the received device identification data; and
in response to the received first query, causing to be sent to the service a response that indicates different data associated with the device identification data based on a database of device characteristics, wherein the service is adapted based on the device identification data.

10. An apparatus of claim 9, wherein the device identification data comprises a time stamp and the second query is initiated within a threshold time of the time stamp.

11. An apparatus of claim 9, wherein the device identification data is included in a request message directed to a universal resource locator (URL) for the service or for a redirection address for the service.

12. An apparatus of claim 9, wherein the device identification data comprises user profile data.

13. An apparatus of claim 9, wherein the device identification data indicates a specific mobile communication device and the different data indicates a device characteristic of the specific mobile communication device.

14. An apparatus of claim 9, wherein the device identification data indicates a specific device characteristic and the different data indicates a mobile communication device associated with the specific device characteristic in the database.

15. An apparatus of claim 9, wherein the device identification data indicates a specific mobile communication device and the different data indicates a different mobile communication device that is similar to the specific mobile communication device based on a set of one or more device characteristics associated with the specific mobile communication device and the different mobile communication device in the database.

16. An apparatus of claim 9, wherein the database further comprises data indicating a plurality of device characteristics for a plurality of manufacturers.

17. A method, comprising:
granting access to receive a query indicating device identification data related to a mobile communication device; and
in response to receiving the query, transmitting a response that indicates different data associated with the device identification data based on a database of device characteristics, wherein a service is adapted based on the device identification data.

18. A method of claim 17, wherein the device identification data indicates a specific mobile communication device and the different data indicates a device characteristic of the specific mobile communication device.

19. A method of claim 17, wherein the device identification data indicates a specific device characteristic and the different data indicates a mobile communication device associated with the specific device characteristic in the database.

20. A method of claim 17, wherein the database further comprises data indicating a plurality of device characteristics for a plurality of manufacturers.
